(19) United States
(12) Patent Application Publication
(10) Pub. No.: US 2010/0187702 A1
(43) Pub. Date: Jul. 29, 2010

(54) Method for the creation of shaped plastic lenses from flat substrates through the application of a thin film coating

(75) Inventor: Jeff Pool, Evergreen, CO (US)

Correspondence Address: THE LAW OFFICES OF DENNIS L. COOK, PLLC, 10004 MARATHON COURT, TAMPA, FL, 33615, US

(73) Assignee: Ocean Thin Films, Inc., Largo, FL (US)

(21) Appl. No.: 12/657,338

(22) Filed: Jan. 19, 2010

Related U.S. Application Data
(60) Provisional application No. 61/205,988, filed on Jan. 26, 2009.

(51) Int. Cl. B29D 11/00

(52) U.S. Cl. 264/1.7

(57) ABSTRACT

This disclosure describes a method for shaping flat plastic into curved lenses during the process of depositing a thin film coating that can be applied to any application requiring a shaped lens and a thin film coating. It can be applied to any type of eyewear including but not limited to glasses, goggles, contacts and face shields as well as non-ophthalmic applications. Some application examples are 3D glasses, Laser Protection glasses and Laser Hardening glasses.

### CROSS-REFERENCE TO RELATED APPLICATION

The present application claims the benefit of previously filed co-pending Provisional Patent Application, Ser. No. 61/205,988.

### FIELD OF THE INVENTION

This invention belongs to the field of manufacture of optical lenses with thin film coatings. More specifically it is a new process for manufacturing the optical lens where the thin film stress can be tailored to shape a flat or nearly flat plastic substrate into a lens with a specific radius of curvature.

### BACKGROUND OF THE INVENTION

Traditionally in the eyeglass industry, optical coatings have been applied as a final step on pre-formed or already shaped lenses. This invention puts forth the idea of starting with a flat or nearly flat substrate and creating a curved lens with a specific radius of curvature during the coating process. Through careful control of the variables that affect coating stress, a repeatable and uniform radius of curvature can be attained on lenses.

This technique has several advantages over the traditional technique of coating pre-shaped substrates. When starting with a curved substrate, coating thickness uniformity across the part is affected. It is hard to deposit uniform coatings on curved lenses due the lens shadowing itself and varied distances to the coating source. Non-uniform thickness has an adverse affect on the performance of the coating. By starting with a flat substrate, uniformity problems are mitigated providing superior performance. Flat substrates are also more cost effective to produce. They can be laser cut from plastic sheets and do not require unique molds. This means there is less added value so less is lost when the coating is out of specification. Starting with flat lenses also provides easier handling and simpler tooling for pre-coating and coating operations.

### BRIEF SUMMARY OF THE INVENTION

This invention is a method for shaping flat plastic substrates into curved lenses during the process of depositing a thin film coating. The invention can be used for any application requiring a shaped lens and a thin film coating. It can be applied to any type of eyewear including but not limited to glasses, goggles, contacts and face shields as well as non-ophthalmic applications. Some application examples are 3D glasses, laser protection glasses and laser hardening glasses.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a coated lens demonstrating curvature created with selected coating parameters.

### DESCRIPTION OF THE PREFERRED EMBODIMENT

There are two types of coating stress that are controlled in order to accurately form a plastic lens during coating. There is intrinsic stress that is the result of the microstructure of the deposited film and extrinsic stress that is the result of differences in thermal expansion of the substrate and coating. Intrinsic stress is dictated by the specific coating process (i.e. evaporation techniques such as ion assisted evaporation and sputtering techniques such as magnetron sputtering or ion-beam sputtering) and the coating parameters selected for the given process (i.e. target power/e-beam power/process gas pressures/process temperature/deposition angles/deposition rate/throw distance/coating materials/ion bombardment/substrate thickness/coating thickness). Generally, a denser film has compressive stress and a porous coating has tensile stress. Extrinsic stress is controlled by the selection of substrate material and coating materials based on their coefficient of thermal expansion. During coating, temperature is elevated and controlled in order to take advantage of the selected mismatch in thermal expansion. If the application allows, substrate thickness is an additional control parameter that can be varied. By controlling these factors, lenses can be shaped concave or convex in relation to the coated side.

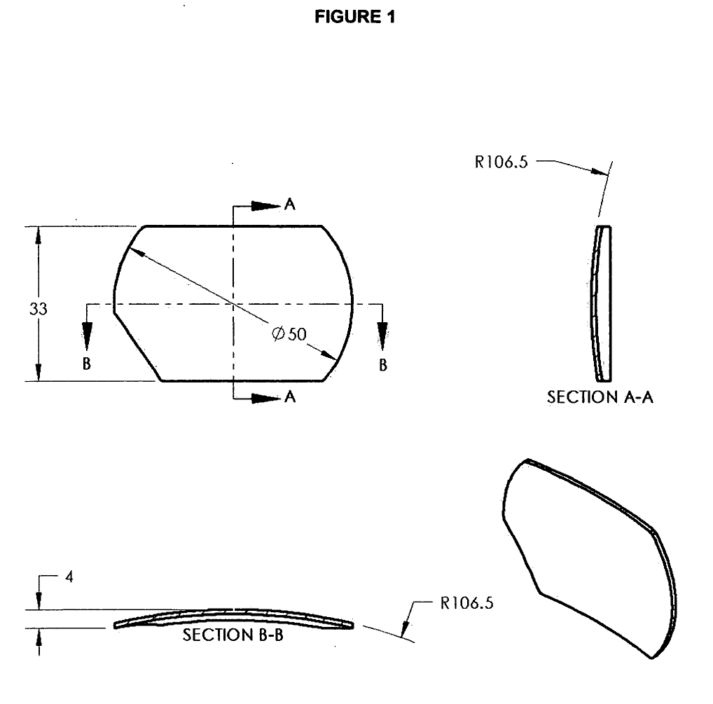

In an embodiment of this invention shown in FIG. 1 the following parameters are used to create a curved lens from a flat plastic substrate by application of a thin film coating in accordance with the method discussed above:
Deposition Process: Reactive Magnetron Sputtering
Coater Configuration: Drum Batch Coater
Throw Distance: 3″
Coating Materials: SiO2/Nb2O5
Substrate Material: CR-39
Substrate Thickness: 1 mm
Coating Temperature: 80 C
Operating Pressure: 2.0E-03 to 3.0E-3 mbar
Target Power: 9 KW
Design Thickness: 3.5 microns

Since certain changes may be made in the above described lens manufacturing process without departing from the scope of the invention herein involved, it is intended that all matter contained in the description thereof or shown in the accompanying FIGURE shall be interpreted as illustrative and not in a limiting sense.

What is claimed is:

1. A method to create a curved lens from a flat plastic substrate by application of a thin film coating comprising:
selecting the coating process and coating parameters to obtain the appropriate intrinsic stress on a flat plastic substrate.

2. The method of claim 1 to create a curved lens wherein the coating process is evaporation, ion assisted evaporation, sputtering, or ion-beam sputtering.

3. The method of claim 1 wherein the coating parameters are target power, e-beam power, process gas pressure, process temperature, deposition angle, deposition rate, throw distance, coating material, ion bombardment, substrate thickness, and coating thickness.

4. A method to create a curved lens from a flat plastic substrate by application of a thin film coating comprising:
selecting the substrate material and coating material to obtain the appropriate extrinsic stress on a flat plastic substrate based on differing coefficients of thermal expansion of the substrate material and the coating material and elevating and controlling the temperature during coating and cooling to apply the correct extrinsic stress.

5. A method to create a curved lens from a flat plastic substrate by application of a thin film coating comprising:
selecting the coating process and coating parameters to obtain the appropriate intrinsic stress on a flat plastic substrate; and,
selecting the substrate material and coating material to obtain the appropriate extrinsic stress on a flat plastic substrate based on differing coefficients of thermal expansion of the substrate material and the coating material and elevating and controlling the temperature during coating and cooling to apply the correct extrinsic stress.

6. The method of claim 5 to create a curved lens wherein the coating process is evaporation, ion assisted evaporation, sputtering, or ion-beam sputtering.

7. The method of claim 5 wherein the coating parameters are target power, e-beam power, process gas pressure, process temperature, deposition angle, deposition rate, throw distance, coating material, ion bombardment, substrate thickness, and coating thickness.
